(19) United States
(12) Patent Application Publication
(10) Pub. No.: US 2010/0025165 A1
(43) Pub. Date: Feb. 4, 2010

(54) Disk Brake Comprising an Energy Store

(75) Inventors: Alfred Utzt, Fuerstenfeldbruck (DE); Karlheinz Heidl, Fuerstenfeldbruck (DE)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme Fuer Nutzfahrzeuge GmBH, Muenchen (DE)

(21) Appl. No.: 12/281,934

(22) PCT Filed: Mar. 2, 2007
(86) PCT No.: PCT/EP2007/001796

§ 371 Date: Jan. 30, 2009

(30) Foreign Application Priority Data
Mar. 6, 2006 (DE) 10 2006 010 216.9

(51) Int. Cl. F16D 65/14

(52) U.S. Cl. 188/71.8

(57) ABSTRACT

A disk brake is provided, the disk brake including at least one energy storing element and a deflecting mechanism which is controllably configured to deflect the force flux of the energy storing element in a transverse direction toward a brake disk in order to clamp at least one brake lining against the brake disk.

### CROSS REFERENCE TO RELATED APPLICATIONS

This application is a U.S. National Phase Entry under 35 U.S.C. §371, of PCT Application No. PCT/EP2007/001796, filed Mar. 2, 2007, which claims priority under 35 U.S.C. §119 to German Patent Application No. 10 2006 010 216.9 filed Mar. 6, 2006, the entire disclosures of which are herein expressly incorporated by reference.

### BACKGROUND AND SUMMARY OF THE INVENTION

The invention relates to a disk brake according to the preamble of claim 1.

In disk brakes the braking force needed for braking a vehicle is transmitted to the disk by means of brake linings. In order to obtain an adequate braking action a correspondingly high input of energy and force is required. Fitting the vehicle with a spring energy accumulator, which acts on the brake linings in such a way that it presses them against the disk for braking effect, is already known. To release the brake, the operating pressure of an air brake system, for example, is made to impinge upon this spring brake cylinder, in order to cancel the braking action on the motion of the vehicle, such as a rail vehicle, for example.

Familiar from the sphere of drum brakes is an expanding wedge device, in which a wedge element with the drive points of the brake shoes arranged on its wedge faces is displaced between these, thereby transmitting a braking force to the brake shoes by spreading them apart. The expanding wedge is driven pneumatically or hydraulically by an external brake cylinder, for example.

These devices have been shown to work, but one disadvantage has proved to be the fact that a large amount of energy has to be generated in order to apply the braking force to the respective wheel brakes, losses in the respective lines, for which additional energy has to be provided, occurring over the long transmission paths that prevail, especially in the case of rail vehicles.

US 2005/0126864 discloses a disk brake, in which a deflection element is formed from two rotating wedge elements of substantially semicircular cross section, which are capable of swiveling about an axis of rotation with their straight faces in opposition. The rotating-wedge elements here serve to generate a self-intensifying effect.

DE 100 46 981 A1, DE 101 40 076 A1, DE 100 46 177 A1, U.S. Pat. No. 6,332,514, U.S. Pat. No. 6,932,198, DE 299 01831 U1 and DE 103 24 424 A1 are also cited as belonging to the state of the art.

The object of the invention is therefore to create an improved disk brake, compared to the state of the art, which no longer has the aforementioned disadvantages and which affords further advantages.

According to the invention a permanent force is generated by a stored energy element, for example by a tensioned spring, the action of which on the brake linings and hence on the brake disk, can be controlled with as little energy as possible.

The deflection device for deflecting the flux of the stored energy element is controllably configured for applying at least one brake lining in a transverse direction of a brake disk.

On the one hand the deflection device has the advantage that the disk brake is of compact construction and on the other this deflection device in a controllable configuration makes it readily possible to continuously influence the flux of the stored energy element for deflection as a similarly adjustable brake force.

According to the invention at least one stored energy element is arranged in the brake caliper of the disk brake, so that its flux vector runs in a longitudinal direction parallel to the brake disk of the disk brake and perpendicular to the transverse direction, which results in an especially compact construction.

A wedge mechanism is used as controllable deflection device. Here the wedge angle between two wedge elements, or two components acting as wedges, is adjustable. This makes it possible to divide the flux of the stored energy element from one direction in the direction of the brake linings. It is advantageous if the brake caliper is to a certain extent elastic and under the braking forces acting applies a return force for the deflection device.

According to one variant the wedge angle is a swivel angle of a brake lever about a pivot axis fixed in the brake caliper. At its end opposite the pivot axis such a brake lever interacts with a deflection element, which is connected to the stored energy element and a brake lining. It is advantageous here for the deflection element to be guided between the brake caliper and the end of the brake lever opposite the pivot axis, the brake lever at its end opposite the pivot axis having a wedge bearing, which in the course of the swiveling travel of the brake lever is guided on a guide cam of the deflection element.

The deflection element is acted on by the force of the stored energy element and transmits this force via its guide path to the brake lever, which introduces this force into the brake caliper, when the brake lever is in a release position. The brake lever is capable of swiveling about this point of introduction in the brake caliper, its other end being guided on the guide path of the deflection device. The swivel angle of the brake lever here forms the wedge angle of the deflection mechanism. In the swiveled position of the brake lever the flux is now divided so that a flux component is generated in the direction of the brake linings, which varies as a function of the swivel angle.

It is particularly advantageous for the actuating force of the brake lever to remain constant both for application and for release of the brake.

In a further embodiment, which may also constitute an invention in its own right, the axis of rotation is coupled to an adjusting device for adjustment in a transverse direction as the brake linings wear. Because the actuating force of the brake lever varies accordingly as the brake linings wear, in a further preferred embodiment the adjusting device operatively interacts with a measuring device for measuring the actuating force of the brake lever.

In an alternative development of the invention the deflection device is formed from two rotating wedge elements of substantially semicircular cross section, which are capable of swiveling about an axis of rotation with their straight faces in opposition and are arranged so that they can be displaced against one another in a recess in the brake caliper.

The rotating wedge elements are here preferably arranged in the recess in the brake caliper so that the first rotating wedge element is displaceably arranged, the second rotating wedge element being connected to a brake actuating device. A simple wedge mechanism with an adjustable wedge angle is consequently created, which can readily be used for continuous adjustment of the braking force of the disk brake. It is furthermore compact and may be integrated into the brake caliper.

The rotating wedge elements in the recess in the brake caliper are here operatively connected in the longitudinal direction to a force input bearing and a transverse bearing and in the transverse direction to a longitudinal bearing and force output bearing. Where roller bearings are used, the friction loss is especially low, which affords a further advantage in reducing the actuating force.

For this purpose the longitudinal bearing and the transverse bearing are fitted in the brake caliper via fixed axes of rotation, the force introduction bearing, rotatable in a first guide, is adjustable in a longitudinal direction and the force output bearing, rotatable in a second guide, is adjustable in a transverse direction, the force input bearing interacting with the stored energy element and the force output bearing interacting with the brake lining.

The brake caliper and the brake linings are to a certain extent elastic and here too, due to the brake forces acting, generate a return force for the deflection device. For this purpose the external contour of the first rotating wedge element furthermore preferably in each case has an eccentric section of an input cam with a first lobe and an eccentric section of an output cam with a second lobe.

The input cam of the first rotating wedge element here projects radially outwards towards the first lobe and the output cam towards the second lobe.

Alternatively the opposing faces of the rotating wedge elements may be of eccentric design.

The input cam of the first rotating wedge element is operatively connected to the force introduction bearing and the output cam of the first rotating wedge element is operatively connected to the force output bearing. The cam shape permits a rolling movement, affording a low frictional resistance, which keeps the actuating forces low.

In a further preferred embodiment, in the release position of the disk brake the flux of the stored energy element is introduced into the brake caliper by the force introduction bearing via the first and second rotating wedge elements and via the transverse bearing, the magnitude of the flux of the stored energy element acting on the brake lining in the transverse direction being adjusted via the force output bearing as a function of the swivel angle of the rotating wedge elements when the latter are in a swiveled position differing from the release position. Here too, the flux is advantageously divided by the deflection device and may even be intensified at certain wedge angles.

A further major advantage is that the force for controlling the controllable deflection device is lower than the force generated by the stored energy element, thereby making it possible to use space-saving actuating units, such as pneumatic and/or hydraulic cylinders or electric motor-powered actuators, for example. The losses in high state-of-the-art energy transmission are thereby significantly reduced.

It is particularly advantageous here if the stored energy element is a spring, a pneumatic cylinder or a tensioned casting, or a combination of these elements, since this creates a permanent or even a rechargeable stored energy in the brake caliper of the disk brake, making it possible to dispense with the high energy transmission to the disk brake of a vehicle required in the state of the art.

A disk brake as described above furthermore has an electric motor-powered actuator for brake actuation. A parking brake is also afforded by a particular configuration of the input and output cams.

Other objects, advantages and novel features of the present invention will become apparent from the following detailed description of the invention when considered in conjunction with the accompanying drawings.

### BRIEF DESCRIPTION OF THE DRAWINGS

FIG. 1. shows a schematic general representation of a wedge mechanism in accordance with an embodiment of the present invention with different wedge angles;

FIG. 2. shows a schematic representation of a disk brake in a release position;

FIG. 3. shows a schematic representation of the disk brake according to FIG. 2 in a first braking position;

FIG. 4. shows a schematic representation of the disk brake according to FIG. 2 in a second braking position;

FIG. 5. shows a schematic representation of an exemplary embodiment of the disk brake according to the invention in a release position;

FIG. 6. shows a schematic representation of the disk brake according to FIG. 5 in a first braking position;

FIG. 7. shows a schematic representation of the disk brake according to FIG. 5 in a second braking position; and

FIG. 8. shows a detail of a further variant of the disk brake in FIGS. 5 to 7.

### DETAILED DESCRIPTION OF THE DRAWINGS

The same reference numerals apply to parts performing an identical or similar function. In all figures an x, y, z system of co-ordinates is represented for the purpose of orientation, in which a longitudinal direction parallel to a brake disk 2 of the disk brake 1 is denoted by x, a transverse direction perpendicular to the longitudinal direction x is denoted by y and a direction perpendicular to the plane of projection is denoted by z. In this case the transverse direction y runs parallel to the wheel axle of the disk brake 1.

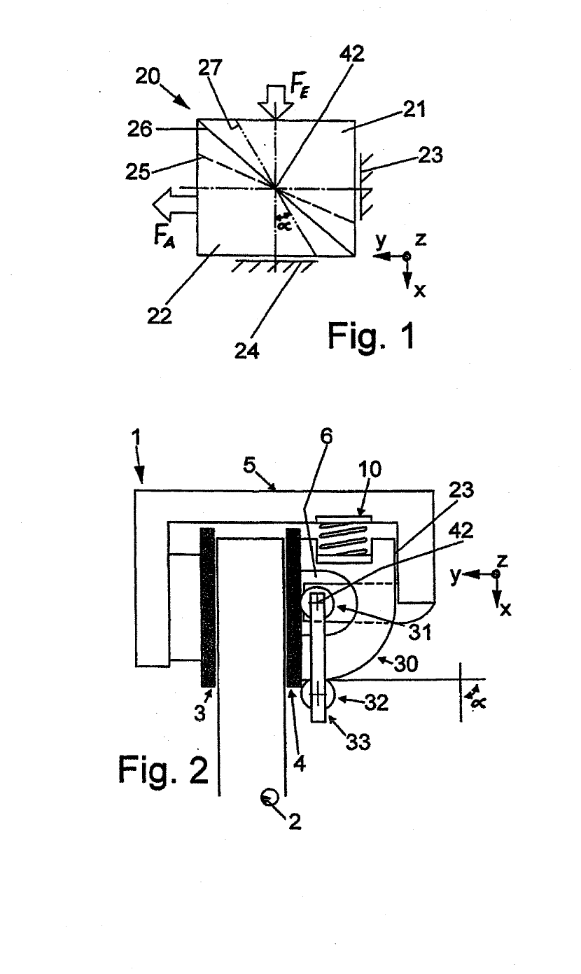

In FIG. 1 a wedge mechanism is represented schematically as a deflection device 20 for an input force F_{E} into an output force F_{A}.

The input force F_{E} acts on a first wedge element 21, which is laterally guided in a longitudinal direction x against a longitudinal guide. It is connected to a second wedge element 22 by an inclined separation joint 25, 26, 27, the three separation joints 25, 26, 27 representing three different wedge angles α, which is drawn in only at the separation joint 27 between this and the perpendicular or longitudinal direction x.

The second wedge element 22 is guided in a transverse direction y by a transverse guide 24.

On introduction of the input force F_{E} into the first wedge element 21, this element is pressed downwards in the longitudinal direction x and displaces the second wedge element 22 towards the left in a transverse direction y, thereby transmitting the output force F_{A}. The output force F_{A} varies as a function of the wedge angle α, which is here shown in three different magnitudes by the three different separation joints 25, 26, 27. In the case of the first separation joint 25, the wedge angle α is 63° from the separation joint 25 to the longitudinal direction x and 27° from the separation joint 25 to the transverse direction y. In this case the output force F_{A}=½ F_{E}. With α=45°, F_{A}=½ F_{E} and for α=27° (to the longitudinal direction x) F_{A}=2F_{E}. An attenuation and also an intensification of the force are therefore possible, the flux being deflected. In this case, in which α=90°, the input force F_{E} is introduced directly into the transverse guide 24 in the longitudinal direction. No force component is here generated in the transverse direction y, so that where α=90°, F_{A}=0.

For a service brake, however, this wedge angle or also a deflection angle α must be continuously adjustable.

For this purpose FIG. 2 now shows a disk brake 1 with a disk 2, which is only represented in part. Bearing against this are a first and a second brake lining 3, 4, which are enclosed by a brake caliper 5. The first brake lining 3 is connected to one leg of the brake caliper 5. The brake caliper 5 is extended towards the right-hand side of the drawing and a deflection element 30, which is guided in a longitudinal direction x by the right-hand leg of the brake caliper 5, is arranged between the leg on this side and the second brake lining 4. The right-hand leg here forms the longitudinal guide 23 (see FIG. 1).

The deflection device 30 is connected on its left-hand side to the second brake lining 4, the element having a recess 6, which encloses an axis of rotation 42. In this example the axis of rotation 42 is firmly connected to the brake caliper 5. Fitted to said axis is a fixed bearing 31, on which a brake lever 33 is pivotally fixed. At its end opposite the fixed bearing 31 the brake lever 33 has a wedge bearing 32, which is guided on a guide path 34 of the deflection element 30 and which in operation in principle forms the longitudinal guide 23 and the transverse guide 24 according to FIG. 1 for the deflection element 30.

On its upper side the deflection element 30 is connected to a stored energy element 10, in this example a tensioned spiral spring, which is braced against the brake caliper 5, the direction of the force of the stored energy element 10 acting on the deflection element 30 in the longitudinal direction x.

In FIG. 2 the disk brake 1 is shown in a so-called release position. The force of the stored energy element 10 presses the deflection element 30 against the wedge bearing 32. The flux of the stored energy element 10 acts directly in the longitudinal direction x and is absorbed by the wedge bearing 32 on the guide path 34 of the deflection element 30, and transferred via the brake lever 33 into the fixed bearing 31 and hence into the brake caliper 5. No force component occurs in a transverse direction y, so that consequently no application force is exerted on the brake lining 4.

The deflection element 30 and the brake lever 33 form the deflection device 20 according to FIG. 1, the wedge angle α in this release position shown in FIG. 2 being 90°.

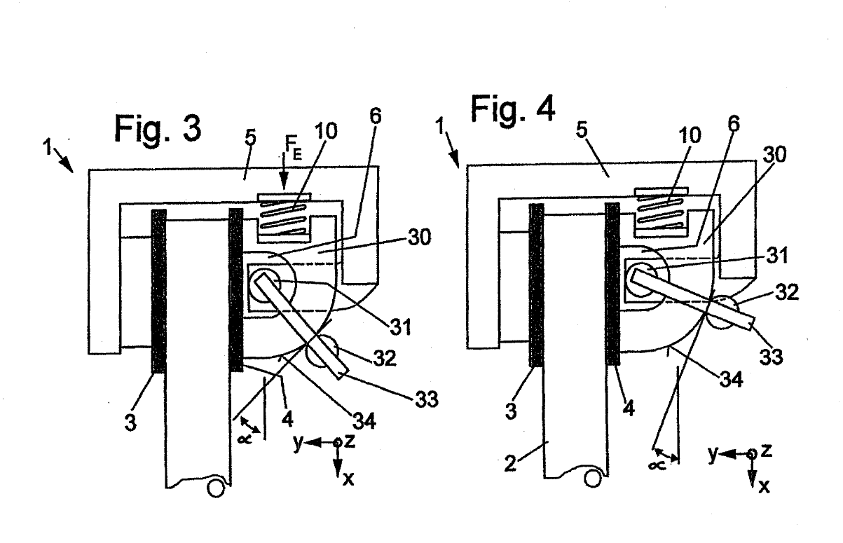

If the brake lever 33 is now swiveled anticlockwise about the fixed bearing 31, the wedge angle α being less than 90°, this will permit an adjustment of the wedge angle α and also of the output force F_{A}, which here forms the force component in a transverse direction y of the input force F_{E} of the stored energy element 10 acting on the brake lining. In FIG. 3 this is shown in an intermediate braking position of the brake lever 33 where α=45°.

Guiding of the wedge bearing 32 on the guide path 34 of the deflection element 30 allows swiveling of the brake lever 33 with simultaneous transverse guiding of the deflection element 30. The force component in a transverse direction y is here equal to the force of the stored energy element 10. The deflection element 30 is here displaced in a transverse direction y towards the brake disk 2. The recess 6 here serves as clearance for the fixed bearing 31. The movement of the deflection element 30 in a transverse direction y is compensated for by an expansion of the stored energy element 10.

FIG. 4 shows an instance in which α is approximately 27°. This position of the brake lever 33 is intended for braking with a high braking force. This position of the brake lever intensifies the force of the stored energy element 10.

When the application force is applied in a transverse direction y, the brake caliper 5 is elastically tensioned. This generates a return force for the deflection element 30, as soon as the brake lever 33 is moved back in the direction of the release position (see FIG. 2). The guide path 34 of the deflection element 30 is preferably configured so that the least possible expansion occurs in a longitudinal direction x and the deflection element moves principally in a transverse direction y perpendicular to the brake disk 2.

The movement of the brake lever 33 advantageously requires only a small amount of energy, and where the wedge bearing 32 is designed as a roller bearing this is mainly the bearing pressure, which acts in opposition to the force of the stored energy element 10.

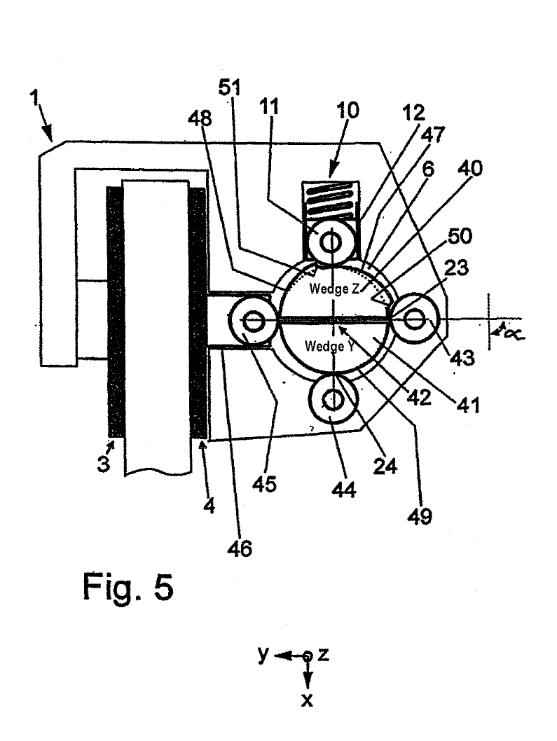

The brake actuating device for all exemplary embodiments, in particular also the rotating wedge element in FIG. 5 et seq. may be of electrical, pneumatic, hydraulic or purely mechanical design and actuation is possible using little actuation force.

Instead of a spiral spring as stored energy element 10, a leaf spring, a pneumatic cylinder or a combination of these is also feasible. A tensioned casting, which corresponds in its elasticity to the brake caliper 5, is likewise possible.

If it is chosen to design the stored energy element 10 with a combination of one or more springs for a parking brake function and one or more pneumatic cylinders for the service brake, the pneumatic cylinders may be provided with non-return valves, that is to say a single filling of these would suffice as stored energy. They would be topped up only in the event of a leak occurring.

Since the parking brake springs of necessity act together in parallel at each braking, both these and the pneumatic cylinders can be correspondingly small in design.

Actuation of the brake lever 33 is possible by means of a separate pneumatic cylinder, since the brake lever 33 only controls the braking force. It therefore needs relatively little pressure and volume, so that it advantageously helps to reduce substantially the air supply needed on the vehicle in question.

The movement of the brake lever 33 requires the same force to apply and to release the brake. As the brake linings 3, 4 wear, the wedge bearing 32 departs from its ideal path on the guide path 34 of the deflection element 30. This results in different force on the brake lever 33 when applying and releasing the brake. In a further embodiment, which may also be regarded as an invention in its own right, this can be measured, for example via measuring devices such as strain gauges, an electrical adjusting device being provided, which adjusts the fixed bearing 31 in a transverse direction y towards the brake disk 2, until the actuating forces on the brake lever 33 are again equal.

FIGS. 5 to 7 show a second exemplary embodiment of the disk brake 1 according to the invention in different positions.

FIG. 5 represents the release position of the disk brake 1. In contrast to FIG. 2, the right-hand section of the brake caliper 5 has a circular recess 6, in which two rotating wedge elements 40 41 are designed to swivel about the axis of rotation 42. The rotating wedge elements 40, 41 each have a substantially semicircular cross section and are arranged with their straight faces in opposition, these faces being able to slide on one another or being displaceable against one another by means of suitable rollers.

The rotating wedge elements 40, 41 are supported in different rollers 11, 43, 44, 45, which in a longitudinal direction x and a transverse direction y each enclose the rotating wedge elements 40, 41 as a deflection device 20. A force input bearing 11 is here displaceably arranged in a first guide 12 in the brake caliper 5, the force input bearing 11 being arranged between the stored energy element 10 and the first rotating wedge element 40, into which it introduces the force of the stored energy element 10. In the release position shown in FIG. 5 the straight lower face of the upper, first rotating wedge element 40 then transmits the force to the straight upper face of the lower, second rotating wedge element 41, which in turn is supported on the transverse bearing 44 (see reference numeral 24 in FIG. 1). The transverse bearing 44 introduces the transmitted force of the stored energy element 10 into the brake caliper 5 in a longitudinal direction x. In this position no force component is generated in the transverse direction y.

Both rotating wedge elements 40, 41 are laterally supported in a transverse direction y by a longitudinal bearing 43 (see reference numeral 23 in FIG. 1) and by a force output bearing 45. The force output bearing 45 is rotatably and displaceably supported in a second guide 46, the latter being connected to the brake lining 4.

The first rotating wedge element 40 has sections 47, 48 on its outer face, which are designated as input cam 47 and output cam 48. These cams 47 and 48 are here of eccentric design and extend radially outwards two lobes 50 and 51. Their function will be described further below. The lower rotating wedge element 41 has a semicircular external contour and is driven by an actuating device for braking, in such a way that it is swiveled anticlockwise about the axis of rotation for application of the brake lining. The swivel angle is the wedge angle α.

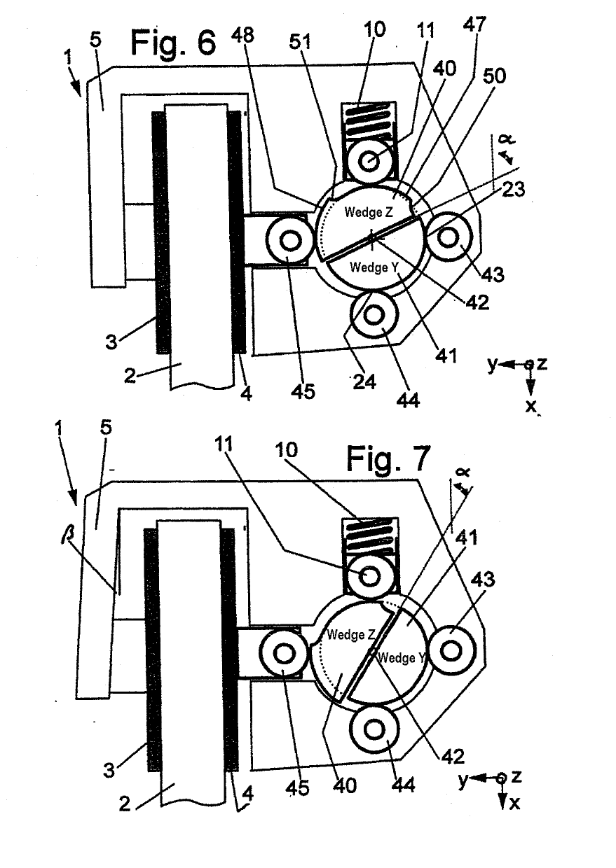

FIG. 6, like FIG. 3, shows a position of the disk brake 1 for an intermediate braking force. The force exerted by the stored energy element 10 via the force input bearing 11, which rolls on the input cam 47, causes the upper rotating wedge element 40 to move toward the left, the force output bearing 45 rolling on its output cam 48 and through the second guide 12 moving the brake lining 4 in a transverse direction y towards the brake disk 2. In so doing the underside of the first rotating wedge element 40 slides or rolls on the fixed, opposing upper side of the second rotating wedge element 41 with a relative movement from its central position, which it occupied in the release position (see FIG. 5).

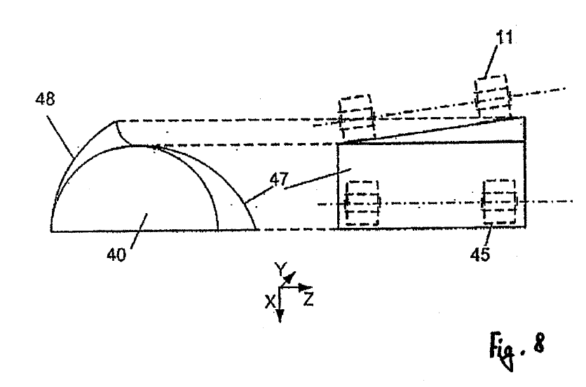

FIG. 7 now shows the minimal deflection angle α, the first rotating wedge element 40 being displaced yet further in relation to the second rotating wedge element 41. The tensioning of the brake caliper is here shown exaggerated with an angle β.

The eccentric tracks or cams 47, 48 on the outside of the first rotating wedge element 40 must in this embodiment be designed so that in any angular position of α they keep the bearings 45 and 11 on the outermost point of the track perpendicular to the axis of rotation 42. Thus it is advantageously possible to achieve a relatively light swiveling of the two rotating wedge elements 40, 41 as controllable deflection device 20.

It is also a feature of this second exemplary embodiment that when the brake is released, the elasticity of the expanded brake caliper has a reactive effect, via the now increasing deflection angle α, on the stored energy element 10, the action of which is attenuated, pressing the brake into its release position.

When the deflection angle α has again assumed an angle of 90° (see FIG. 5), the so-called air gap between the brake lining 3, 4 and the brake disk 2 is re-established, since the brake caliper 5 is no longer expanded and there is no longer any force component acting in a transverse direction y on the brake lining 4.

In order to compensate for the different compressibility of the brake linings, it is advantageous if the tracks 47, 48 have a conical shape in the Z axis and the rotating wedge element 40 is displaceable in this axis (FIG. 8).

In the case of a new brake lining, compressible by virtue of its lining thickness, the rotating wedge element 40 is displaced in such a way that the bearings 11 and 45 fit on the greatest prevailing radius.

As wear to the linings increases, these become less compressible and the travel of the rotating wedge element 40 in the Y axis becomes smaller, the travel in the X axis also being equally reduced.

In order to keep the bearings 11 and 45 on the outermost point of the tracks at any time, the rotating wedge element 40 is shifted in the Z axis towards a diminishing radius. This may be achieved by a separate drive or by coupling to the wear-adjuster, since this responds anyway to the diminishing thickness of the lining.

In a corresponding development, an electromechanical braking system may be designed with an integral parking brake (spring energy accumulator as stored energy element 10), which has an advantageously low energy consumption, since the actuating force for the disk brake 1 according to the invention only controls the braking force of the stored energy element 10. The braking force is deflected by the controlled deflection device 20 and is adjusted commensurately as a function of the deflection angle α.

This low energy requirement needed for actuation also advantageously serves to simplify the system safety, for example redundancy, through a second battery/power supply.

Although the present invention has been described above with reference to preferred exemplary embodiments, it is not limited to these but lends itself to modification in many different ways.

Thus, for example, greater numbers of the rotating wedge elements 40, 41 and also of the deflection element 30 could be fitted in parallel.

Similarly, multiple stored energy elements 10 might be provided, various types of combination also being possible.

It is also feasible for the opposing faces of the rotating wedge elements 40, 41 to take the form of sliding faces or raceways, the external contours being of semicircular design.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1 Disk brake
2 Brake disk
3 First brake lining
4 Second brake lining
5 Brake caliper
6 Recess
10 Stored energy element
11 Force input bearing
12 First guide
20 Deflection device
21 First wedge element
22 Second wedge element
23 Longitudinal guide
24 Transverse guide
25 First separation joint
26 Second separation joint
27 Third separation joint
30 Deflection element
31 Fixed bearing
32 Wedge bearing
33 Brake lever
34 Guide cam
40 First rotating wedge element
41 Second rotating wedge element
42 Swivel axis
43 Longitudinal bearing
44 Transverse bearing
45 Force output bearing
46 Second guide
47 Input cam
48 Output cam
50 First lobe
51 Second lobe
x Co-ordinate, longitudinal direction
y Co-ordinate, transverse direction
z Co-ordinate
F_{E} Input force
F_{A} Output force
α Wedge angle
β Angle

1-18. (canceled)

19. A disk brake, comprising:
a brake caliper; and
at least one stored energy element and a deflection device,
wherein
the at least one stored energy element is arranged in the brake caliper with a force flux vector of the at least one stored energy element aligned in a longitudinal direction which is parallel to a brake disk straddled by the brake caliper,
the deflection device is arranged to deflect at least a portion of a force generated by the at least one stored energy element is directed in a transverse direction which is perpendicular to the brake disk, and
the deflection device is a wedge mechanism arranged to rotate about an axis of rotation fixed in the brake caliper through an adjustable wedge angle.

20. The disk brake as claimed in claim 19, wherein
the deflection device is formed from two rotating wedge elements of substantially semicircular cross section, the two rotating wedge elements being arranged to swivel about the axis of rotation, with straight faces of the two rotating wedge elements facing one another and being displaceable against one another in a recess in the brake caliper.

21. The disk brake as claimed in claim 20, wherein
the rotating wedge elements are arranged in the recess in the brake caliper so that a first one of the two rotating wedge elements is displaceably arranged and that a second one of the two rotating wedge elements is connected to a brake actuating device.

22. The disk brake as claimed in claim 21, wherein
the rotating wedge elements are operatively connected in the longitudinal direction to a force input bearing and a transverse bearing, and in the transverse direction to a longitudinal bearing and force output bearing.

23. The disk brake as claimed in claim 22, wherein
the longitudinal bearing and the transverse bearing are fitted in the brake caliper on fixed axes of rotation,
the force introduction bearing is rotatable in a first guide and is adjustable in the longitudinal direction,
the force output bearing, is rotatable in a second guide and is adjustable in the transverse direction, and
the force input bearing is arranged to interact with the stored energy element, and the force output bearing is arranged to interact with a brake lining arranged between the brake caliper and the brake disk.

24. The disk brake as claimed in claim 19, wherein
an external contour of the first rotating wedge element has an eccentric section of an input cam with a first lobe and an eccentric section of an output cam with a second lobe.

25. The disk brake as claimed in claim 24, wherein
the input cam of the first rotating wedge element projects radially outwards towards the first lobe, and the output cam projects radially outwards towards the second lobe.

26. The disk brake as claimed in claim 25, wherein
the straight faces of the rotating wedge elements are eccentric.

27. The disk brake as claimed in claim 26, wherein
the input cam of the first rotating wedge element operatively interacts with the force input bearing and the output cam of the first rotating wedge element operatively interacts with the force output bearing.

28. The disk brake as claimed in claim 19, wherein
the wedge angle is a swivel angle of a brake lever about a pivot axis fixed in the brake caliper, and
at an end of the brake lever opposite a pivot axis end, the brake lever interacts with a deflection element in the brake caliper positioned between the stored energy element and a brake lining facing the brake disk.

29. The disk brake as claimed in claim 28, wherein
the deflection element is guided between the brake caliper and the end of the brake lever opposite the pivot axis end, the brake lever at its end opposite the pivot axis end having a wedge bearing which is guided on a guide cam of the deflection element when the brake lever is rotated.

30. The disk brake as claimed in claim 29, wherein
in a release position of the disk brake, the brake lever absorbs the entire force of the stored energy element and introduces the force into the brake caliper, and
when the brake lever is rotated to a swiveled position away from the release position, the swivel angle of the brake lever determined the magnitude of the portion the force of the stored energy element directed in the transverse direction to displace the deflection element in the transverse direction.

31. The disk brake as claimed in claim 30, wherein
the disk brake is arranged such that when the disk brake is released after braking, an elasticity of the brake caliper produces a return movement of the brake lining.

32. The disk brake as claimed in claim 19, wherein
the stored energy element is at least one of a spring, a pneumatic cylinder and a tensioned casting.

33. The disk brake as claimed in claim 19, wherein
the brake lever is rotated by an electric motor-powered brake actuating device.

34. The disk brake as claimed in claim 19, wherein the axis of rotation is movable by an adjusting device in a transverse direction to compensated for brake lining wear.

35. The disk brake as claimed in claim 34, wherein
the adjusting device is operatively connected to a measuring device for measuring an actuating force of the brake lever.

36. The disk brake as claimed in claim 19, further comprising:
a parking brake.
